(19) United States
(12) Patent Application Publication
(10) Pub. No.: US 2005/0240799 A1
(43) Pub. Date: Oct. 27, 2005

(54) Method of network qualification and testing

(76) Inventors: Charles T. Manfredi, Oakhurst, NJ (US); Rick E. Svatek, Parker, CO (US); Roy McCune, Germantown, NY (US); Yves DuPont, San Francisco, CA (US)

Correspondence Address: AGILENT TECHNOLOGIES, INC.;Legal Department, DL 429, Intellectual Property Administration, P.O. Box 7599, Loveland, CO, 80537-0599, US

(21) Appl. No.: 10/822,317

(22) Filed: Apr. 10, 2004

(51) Int. Cl. G06F 11/00

(52) U.S. Cl. 714/4

(57) ABSTRACT

A method of network qualification and validation is presented. The network qualification and validation method is performed to meet various government and regulatory standards. In one embodiment, networks associated with regulated environments are defined. The networks are defined based on the applications running on the network. A series of methodologies known as the Design Qualification, Installation Qualification and Operation Qualification are defined. Each methodology uses direct testing of the network to qualify the network. In addition, each methodology produces a consistent, repeatable, standardized, defensible and objective validation and qualification when applied to any network. As a result, the integrity of the network and compliance with government regulations is maintained.

### DESCRIPTION OF THE RELATED ART

Companies that produce products such as drugs, chemical compositions and biological compositions that are sold to the public or impact the public welfare are regulated by government entities. To protect the public welfare, these entities have promulgated exhaustive regulations and procedures for ensuring the viability of products prior to releasing the products to the public.

The regulations specify the requirements for laboratory testing, animal studies, clinical trials, regulatory registration, etc. In addition, the products are often tested for identity, strength, quality, purity and stability before they can be released to the public. In recent times, government entities have started to regulate the manufacturing facilities and laboratories used to manufacture the products. As a result, a product such as a drug that is approved for distribution to the public must be produced in a lab that is compliant with various laws and government regulations. This ensures that the products are consistent and once again that the public is protected.

Initially the regulation of the manufacturing facilities was directed at the hardware used to manufacture the products. For example, the mixing machines, the measuring machines, the feedback and control systems in the laboratory, etc were regulated. However, with the advancement and integration of computer systems, many manufacturing systems include computers. As a result, regulations have now extended to the computers integrated into the manufacturing process and the computers used to control the manufacturing process. Therefore, computers that are an integral part of the manufacturing process are also regulated.

Recently, regulations have extended to cover all computer and networks used in association with a laboratory and/or manufacturing facility producing products that are distributed to the public. This includes the computers and networks that control the manufacturing process as well as the computers and networks that carry, store and process information associated with the laboratory and/or manufacturing facility. This may include any computers and networks associated with the laboratory and/or manufacturing facility such as the networks used by facility personnel to communicate e-mail, to archive data, to perform stand-alone functions such as word processing, etc.

Currently there is recognition that infiltration of computers and/or networks associated with a laboratory and/or manufacturing process may lead to problems and inconsistencies in the products produced by the laboratories and/or manufacturing facilities. For example, a computer virus in an e-mail traveling on a network associated with a facility can ultimately result in disastrous effects in the production of the product produced by the facility. Further, something less devious such as a change in the network architecture of a computer network associated with a facility, may ultimately effect the product manufactured or tested by the facility.

In response to these new regulations, a number of test and qualification methodologies have been developed. The conventional methodologies are often subjective and vary drastically depending on the network architecture. Further, conventional methodologies are typically applied prior to the operation of applications on the network and as such do not take the applications operating on the network into account. As a result, some of the fundamentals of qualification and validation methodologies such as repeatability, standardization, and objectivity are violated.

Thus, there is a need in the art for a method of qualifying and validating networks associated with a manufacturing/testing facility that is consistent, repeatable, can be standardized and is objective. Further, there is a need for a method of qualifying and validating networks associated with a manufacturing/testing facility that accounts for the applications running on the network.

### SUMMARY OF THE INVENTION

A methodology for qualifying and validating computer and communication networks associated with regulated environments such as product facilities is presented. It should be appreciated that the methodology of the present invention may be applied to any environment operating under government regulations. This includes environments such as office environments, research and development environments and any other environment in an organization that are required to comply with government regulations. The methodology produces a consistent, repeatable, standardized, defensible and objective validation and qualification when applied to any network. In one embodiment of the present invention the methodology is implemented as a systematic process that follows the deployment lifecycle of a computer and/or communication network.

In one embodiment, the methodology of the present invention, includes, but is not limited too, a variety of novel features:
1) the method is predicated on direct, dynamic, measurement utilizing tools created for network troubleshooting in a novel way to provide data-rich network assessment;
2) the method is application constrained. The scope of the network is defined by the interconnectivity requirements and resource dependencies of the applications operating on the network;
3) the method utilizes complex data mining techniques to extract trends and issues, which are then compared to well-defined acceptance criteria. This results in the reporting of easy to understand qualitative assessments;
4) the method follows the deployment cycle of network equipment, conforms to the industry-familiar, well-characterized qualification process cycle of design culminating in installation, which then leads to operation;
5) the method facilitates the qualification of existing networks. Existing network components are evaluated according to industry best practices and then demonstrated, through measurement, to fulfill the functions that the design calls for.

In one embodiment of the present invention, the methodology begins with a verification of the computer and/or communications network design from an application perspective. Documentation defining the scope, identification, and evaluation of the computer and/or communication process are the output of the early stages of the methodology. As such, the outputs of the early stages of the methodology serve as an audit-trail and are then used as input for later qualification stages.

In one embodiment; (1) a network under test is defined from an application perspective; (2) a set of qualitative measures are applied to test the network under test; and (3) the results of the test are combined and analyzed to produce a qualitative assessment of the state of the networks compliance with various standards. For example, in one embodiment, the network under test is defined based on applications operating on the network. As such, applications on the network are identified and an inventory of the devices associated with the applications is documented.

Tests are then performed on the applications and the devices/components of the network. The tests provide an objective, repeatable and standardized approach to quantitatively defining the operation of the network. A method is then used to combine and analyze the results of the test to assess the state of compliance of the network with various regulations and standards.

The methodology of the present invention follows the deployment lifecycle of a network. In one embodiment, the deployment lifecycle of a network includes the steps of design, installation and operation. As such, a network design qualification methodology (DQ) is presented, a network installation qualification methodology (IQ) is presented and a network operations qualification methodology (OQ) is presented. Each methodology uses techniques to characterize the network and verify the suitability of a network to support specific applications.

In one embodiment, the network design qualification methodology (DQ) is implemented to analyze and document a network based on application-specific network requirements. As such applications are identified and the network is characterized in terms of the applications. For example, an inventory of network components associated with various applications is defined. In one embodiment, the network components associated with the applications may be referred to as the network under test. By monitoring the network under test at precise testing points, the DQ may be used to verify the network definition and evaluate the network design for supportability, network isolation, and suitability to meet critical application dependencies.

In one embodiment, the network installation qualification methodology (IQ) is used to document the suitability of the network under test to support processes required by the applications used to define the network under test. Successful completion of the IQ provides reasonable assurance that the network was assembled from components that allow the network to function as an integrated system.

In one embodiment, following the IQ an Operations Qualification methodology (OQ) is performed. The OQ methodology is implemented to test operational qualification/performance verification (OQ/PV) of the network under test. The OQ includes the methods and documentation used to evaluate the networks operational characteristics according to the intended use of the network under test. Successful completion of the OQ provides a high degree of assurance that the network under test is operating according to the published acceptance limits of the network under test.

In one embodiment of the DQ:
1) the deployed network design is evaluated against industry best practices and then measured for compliance with the initial design; and
2) the design is evaluated for compliance of:
   application critical dependencies;
   network isolation from unexpected or unwelcome intrusions;
   supportability and monitoring access; and
   administrative and infrastructure support.

In one embodiment of the Instrument Qualification (IQ):
1) application constrained network components and system topology are fully documented;
2) direct measurement is used to verify the veracity of the topology;
3) a baseline health snapshot of the system's operational character is captured and assessed according to predetermined acceptances.

In one embodiment of the Operation Qualification (OQ):
1) network performance is evaluated without employing the application to provide traffic. This separates the system performance from the network, which clarifies the individual contribution of the system performance versus the network performance;
   synthetic data probes (i.e., network traffic generators) perform network stress and loading. These short-term stresses are analogous to those used in cardiac stress testing. The stress-loading determines the effect of traffic on the network without causing catastrophic failures. The individual tests provide quantitative feedback, but also provide a stressed environment in which health monitoring can be performed;
   different network functional stresses may be determined independently (TCP, UDP, FTP, FTTP, etc);
2) long duration network analysis is performed. The long duration network analysis provides a method to assess:
   periodicity of activity;
   effects of transient operations or processes;
   off hour intruders;
   slow accumulation failures or errors.

A method of qualifying a network comprises the steps of defining a network based on applications running on the network. For example, key applications operating on the network are defined and the components of the network required to support the applications are identified. After defining the network based on the applications network test data is acquired by testing the network in response to defining the network. In one embodiment, test such as network troubleshooting test are performed to acquire the network test data. The network test data may include any application or network related data resulting from a network test or analysis. The network test data is then compared to defined limits. For example, the amount of errors that would be tolerated in a network test is defined. The tolerance levels may be used to establish acceptance criteria. As such acceptance criteria is defined for the network test.

A method of performing design qualification comprises the steps of defining a network based on applications running on the network. In one embodiment, the network includes a network design that describes the network. Network test are then performed to test the network in response to defining the network. The suitability of the network design to run the applications is then determined. In one embodiment, the suitability of the network includes the ability of the network to support the applications. In another embodiment the suitability of the network includes the ability of the network to support critical dependencies in the network. In another embodiment, the suitability of the network includes determining whether the network has the appropriate isolation and security.

A method of performing installation qualification comprises the steps of defining a network based on applications running on the network, the network including components organized in a topology. Performing measurement of the components in the network in response to defining the network based on the applications; and verifying the topology in response to performing the measurement. In one embodiment, the measurement is direct measurement where, for example, troubleshooting tools are used to directly test the network and/or applications.

A method of performing operation qualification comprises the steps of defining a network based on applications running on the network; generating traffic on the network using synthetic stress loads; and differentiating between operation of the application and operation of the network in response to generating the traffic on the network. In one embodiment, the synthetic stress load includes various testing techniques such as traffic patterns that load or exercise different hardware and/or software components of the network.

### BRIEF DESCRIPTION OF THE DRAWINGS

FIG. 1 displays a flow chart detailing an embodiment of the method of the present invention.

FIG. 2 displays a computer architecture capable of implementing the teachings of the present invention.

FIG. 3 displays a flow chart detailing an embodiment of the preliminary workflow 100 detailed in FIG. 1.

FIG. 4 displays a flow chart detailing an embodiment of a DQ 102 detailed in FIG. 1.

FIG. 5 displays a flow chart detailing the infrastructure analysis 302 detailed in FIG. 3.

FIG. 6 displays a flow chart detailing a first stage of an embodiment of the measurement analysis 304 detailed in FIG. 3.

FIG. 7 displays a flow chart detailing a second stage of an embodiment of the measurement analysis 304 detailed in FIG. 3.

FIG. 8 displays a chart detailing an acceptance criteria for an embodiment of the measurement analysis 304 detailed in FIG. 3.

FIG. 9A displays a flow chart detailing an embodiment of a IQ 104 detailed in FIG. 1.

FIG. 9B displays a flow chart detailing an embodiment of a IQ 104 detailed in FIG. 1.

FIG. 10A displays a flow chart detailing an embodiment of a OQ 106 detailed in FIG. 1.

FIG. 10B displays a flow chart detailing an embodiment of a OQ 106 detailed in FIG. 1.

### DETAILED DESCRIPTION

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

In one embodiment of the present invention, a 1) top-level process; a 2) second-level process and a 3) third-level process are implemented to perform network qualification and verification. In one embodiment, the top level process includes a 1) customer pre-qualification assessment (PreQ); 2) a DQ process; 3) an IQ process; 4) an OQ process and a 5) PQ process.

In one embodiment of the top-level process a customer prequalification assessment is defined. The customer pre-qualification includes methods to identify the network under test or to assess the customer's vision of the network under test. For example, the customer pre-qualification may include an inventory or survey of the customer network based on applications operating on the network.

During the top-level process a Design Qualification is defined. The design qualification includes methods performed to assess the suitability of the network design to perform the functions required of the applications deployed in the network. In one embodiment, mitigation is performed if the DQ fails. During the top-level process an Installation Qualification is presented. The installation qualification includes methods performed to fully document the components of the network to provide a fingerprint of the network and to establish a change-managed environment. In one embodiment of the IQ, an initial operation of the network under test is assessed to provide a baseline analysis of the network under test.

During the top-level process an Operation Qualification is presented. In one embodiment, the operation qualification includes methods performed to demonstrate the networks resilience to load and to evaluate the network function throughout an extended operational period. Lastly, during the top-level process a performance qualification is performed. In one embodiment, the performance qualification is performed to demonstrate ongoing performance as a function of time and network changes.

During the second-level process a Pre-qualification is performed. In one embodiment of the present invention, customer completed questionnaires that detail the current design are acquired. The questionnaires includes various characteristics of the network such as, 1) applications operating on the network; 2) components; 3) clients authorized to access the servers; 4) isolated components; 5) and application dependencies.

During the second-level process a Design Qualification is defined. The design qualification includes methods performed to asses 1) network limits, components, and isolation; 2) the design of the network from a supportability standpoint; 3) the network infrastructure; 4) and the network monitoring.

In one embodiment, the network limits, components and isolation is assesses by performing the following steps:
identifying network components as determined by the reach of the application (i.e., components the application directly or indirectly communicates with or cause to operate);
assessing server to client Isolation; and
assessing client to instrument isolation.

In one embodiment, the networks ability to support the applications based on the network design (i.e., design for supportability) is assessed by performing the following steps:
assessing administrative support (i.e., using policy manuals, network closet condition, etc);
assessing access to the network;
determining monitoring access points;
assessing application critical dependencies; and
describing unexpected topologies.

In one embodiment, the network infrastructure is assessed by performing the following steps:
assessing the network infrastructure;
evaluating client hubs; and
assessing Wide-Area Networks (WAN)s.

In one embodiment, the network monitoring is completed by:
performing server monitoring;
determining authorized client access; and
determining unexpected server access.

During the second-level process an Installation Qualification is defined. In one embodiment, assuming a successful completion of the DQ, an Installation qualification is implemented. The IQ includes methods implemented to perform 1) user manual assessment; 2) physical inventory; 3) topology assessment; and 3) a network health snapshot. In an alternative embodiment, when the DQ is not successful, a mitigation report is generated. In one embodiment, the mitigation report includes the corrective actions that would enable the network under test to pass the DQ.

The network health snapshot includes any methods that may be implemented to provide a real-time assessment of the performance of the network. In one embodiment, the network health snapshot includes; a) server to client connection statistics; b) server monitoring: alerts and warnings: c) server monitoring: protocol statistics and d) application space switch statistics.

In one embodiment, the sever to client connections statistics may include:
application space statistics;
connection statistics; and
retransmission statistics.

In one embodiment, the server monitoring: protocol statistics may include:
protocol distribution;
Ethernet statistics; and
IP Statistics.

During the second-level process an operation qualification is defined. One embodiment of the second-level process includes two methods 1) performance predictability and 2) network characterization and long duration analysis. In one embodiment, performance predictability includes a) transient stress testing; b) network response monitoring during stress testing and c) switch port error assessment. In one embodiment transient stress testing may include testing the following:
multi-protocol trace routes;
FTP performance (upload/download);
virtual HTTP performance;
max throughput ((to/from client));
one-way TCP performance (to/from client);
one-way UDP performance (to/from client).

In one embodiment, network response monitoring during stress testing may include collecting the following:
connection statistics;
Ethernet statistics; and
IP statistics.

In one embodiment, network characterization and long duration analysis includes logging and analyzing the following:
application space verification;
connection summary by IP address;
IP connections by day;
protocol distribution and utilization;
retransmissions by day and connection;
alerts and warnings by day and hour;
reset connections by day and hour;
protocol statistics; and
protocol vitals.

During the second-level process a performance qualification is defined. One embodiment of the performance qualification at the second-level process includes ongoing network performance monitoring: 1) performance predictability tests re-run at predetermined intervals; and 2) remote monitoring or remote data reduction of captured log files.

During the third-level process a pre-qualification is performed. In one embodiment of the present invention, customer completed questionnaires about the current design are acquired. For example, a customer supplies information about which support process, hardware, and/or applications are required to support the application-constrained network. This provides application dependencies that may be documented in an application dependencies form.

During the third-level process a Design Qualification is defined. The design qualification includes methods performed to 1) monitor the network; 2) determined authorized client access; and 3) determine unexpected server access.

In one embodiment of the network monitoring, server monitoring is performed. During the server monitoring, an automated snapshot of client/server communication and switch activity is logged and analyzed. The client/server communication and switch activity is then used as a baseline for evaluating traffic flow. For example, a network analyzer is used to monitor live server network traffic. The network analyzer logs utilization and error statistics, displays real time network health, and reports warnings and alerts as it logs. The log and capture files that are generated are saved to create reports.

A Switch Advisor (i.e., an SNMP client software connecting to managed switches) is used to retrieve and log statistical information for each switch port that has a client or server attached. As clients exercise servers, the managed switch accumulates statistics from the time it was last powered-on or restarted. The Advisor reads and reports the values accumulated in the managed switch.

In one embodiment authorized client access is monitored. The authorized client access is monitored using the data gathered through server monitoring. The data is used to verify that all authorized clients have demonstrated the ability to connect to the server.

In one embodiment unexpected server access is monitored. Using the data gathered through server monitoring, the connections made to the server are compared against the list of authorized clients. Any connections which cannot be verified will be considered suspect and result in an exception.

During the third-level process an Installation Qualification is defined. In one embodiment, assuming a successful completion of the DQ, an Installation qualification is implemented. The IQ includes methods implemented to perform a network health snapshot or mitigation if the DQ fails. In the event of a DQ failure, a detailed mitigation requirements report is substituted for the IQ. The IQ would be invalidated in the event of changes required to repair the deficiencies found in the DQ.

In one embodiment, the network health snapshot includes the following:
server to client connections statistics (i.e., such as connection statistics);
server monitoring: protocol statistics (i.e., such as protocol distribution statistics, Ethernet statistics, and IP statistics); and
application space switch statistics.

During the third-level process a Operation Qualification is defined. One embodiment of the third-level process includes two methods 1) performance predictability and 2) network characterization and long duration analysis. In one embodiment, performance predictability includes a) transient stress testing; b) network response monitoring during stress testing and c) switch port error assessment. In one embodiment transient stress testing may include testing the following:
multi-protocol trace route;
FTP performance (upload/download).

In one embodiment, network characterization and long duration analysis includes performing the following:
application space verification; and
retransmissions by day and connection.

During the third-level process a performance Qualification is defined. One embodiment of the performance qualification at the third-level process includes ongoing network performance monitoring: 1) performance predictability tests; and 2) remote monitoring or remote data reduction of captured log files.

In one embodiment, the DQ methodology, IQ methodology and OQ methodology are performed. Each methodology includes method steps and documentation associated with the method steps. The method steps and the documentation associated with the method steps are combined and referred to as a protocol. Therefore, the DQ protocols consist of the DQ method steps and the documentation associated with the DQ method steps. The IQ protocols consist of the IQ method steps and the documentation associated with the IQ method steps. The OQ protocols consist of the OQ method steps and the documentation associated with the OQ method steps.

Throughout the disclosure the terms service provider, operator and customer will be used. The service provider is used to refer to an entity implementing the methodology of the present invention. The operator is a person directed by the service provider. The customer is the owner or entity responsible for the network.

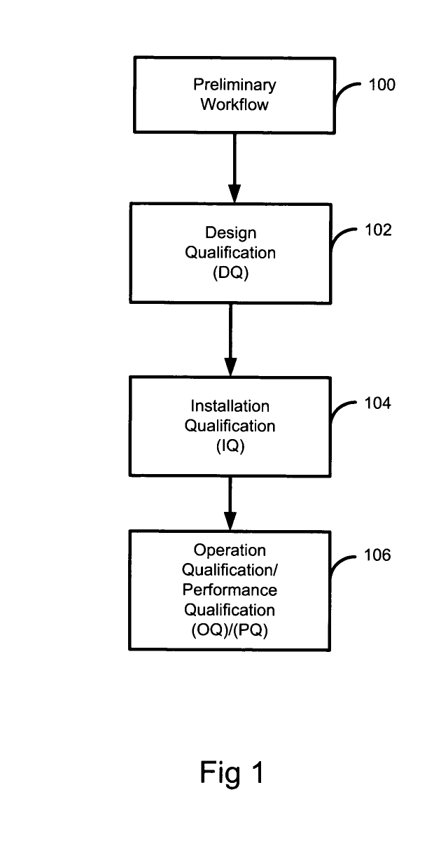

FIG. 1 details an embodiment of a methodology implemented in accordance with the teachings of the present invention. In FIG. 1 a preliminary workflow 100 is performed. Once the pre-qualification is completed a DQ 102 is performed. During the DQ 102 applications are identified and the network under test is defined relative to the applications. Test of all the applications and the components in the network under test are then performed. The results of the test are then documented. The documentation of the network and the results of the test are then provided to the customer for review. In one embodiment, the documentation of the network and the results of the test combine to form the DQ 102 protocol. It should be appreciated that while specific DQ 102 steps will be described and discussed, variations in the methodology may occur and still remain within the scope of the DQ 102 protocol.

In one embodiment, the network under test is rated based on the success or failure of the various tests. For example, a network under test receiving a green or a yellow rating, will receive IQ 104 documentation within a defined time period after the completion of the DQ 102. Networks receiving a red rating will receive a network analysis report identifying network issues and remediation advice to improve the network design.

In one embodiment of the present invention, a rating of green indicates that the network design employs components that allow for supportability, provides critical application dependencies, is reasonably isolated from disruptive traffic, and has low levels of undesirable protocol errors.

In one embodiment of the present invention, a rating of yellow, indicates that while the network shows no apparent critical defects that would prevent it from functioning as intended, there is some indication that problems may exist and/or develop while using the network under test. In one embodiment of the present invention, a rating of red indicates that critical deficiencies have been found and should be mitigated.

Once a DQ 102 is performed an IQ 104 is implemented. In one embodiment, the IQ 104 is implemented to document the configuration, topology, critical monitoring points, and system health of a network under test that received an overall status of green or yellow from the design qualification (DQ). During an IQ 104 the hardware and software manuals are identified, the physical inventory is documented, a topology map of the network under test is developed and a snapshot of the health of the network under test at a specific time is documented. Each stage of the IQ 104 is graded on a pass/fail basis. In addition, the overall IQ 104 is graded on a pass/fail basis. In one embodiment, the test performed in the IQ 104 and the documentation resulting from the IQ 104 steps combine to form the IQ 104 protocol. It should be appreciated that while specific IQ 104 steps will be described and discussed, variations in the methodology may occur and still remain within the scope of the IQ 104 protocol.

Once the IQ 104 is completed an OQ 106 is performed. The OQ 106 is an operational qualification/performance verification (OQ/PV) of the network under test. The OQ 106 defines the methods and documentation used to evaluate the network operational characteristics according to defined specifications and intended use. Successful completion of the OQ 106 provides a high degree of assurance that the network is operating according to the published acceptance limits.

In one embodiment, the OQ 106 is implemented by using direct measurement to evaluate the network's ability to respond to increasing traffic conditions, as well as to provide a comprehensive characterization of network activity patterns over time. In one embodiment, the tests and steps performed during the OQ 106 and the documentation associated with the OQ 106 combine to form the OQ 106 protocol. It should be appreciated that while specific OQ 106 steps will be described and discussed, variations in the methodology may occur and still remain within the scope of the OQ 106 protocol.

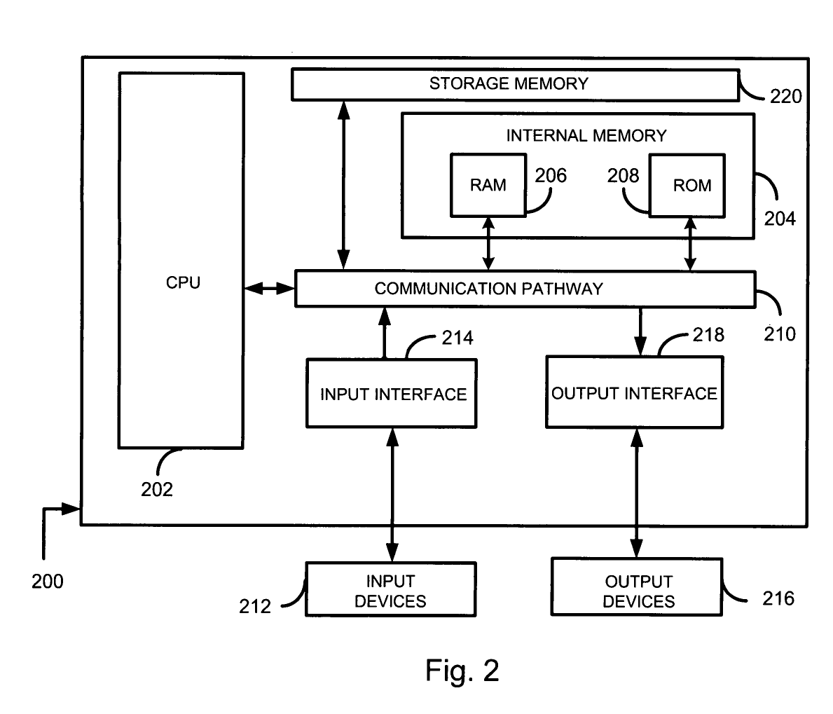

FIG. 2 displays a computer architecture that may be used to implement the method depicted by the flow diagram shown in FIG. 1. Further, throughout the disclosure devices such as a network analyzer, software advisor are used and network test are implemented. The computer architecture of FIG. 1 may be used in combination with the appropriate software to implement the network analyzer, software advisor, and network testing tools required to exercise and test the network. A central processing unit (CPU) 202 functions as the brain of the computer 200. Internal memory 204 is shown. The internal memory 204 includes short-term memory 206 and long-term memory 208. The short-term memory 206 may be a Random Access Memory (RAM) or a memory cache used for staging information. The long-term memory 208 may be a Read Only Memory (ROM) or an alternative form of memory used for storing information. Storage memory 220 may be any memory residing within the computer 200 other than internal memory 204. In one embodiment of the present invention, storage memory 220 is implemented with a hard drive. A communication pathway 210 is used to communicate information within computer architecture 200. In addition, the communication pathway 210 may be connected to interfaces, which communicate information out of the computer 200 or receive information into the computer 200.

Input devices, such as a tactile input device, keyboard, communications connections are shown as 212. The input devices 212 interface with the system through an input interface 214. Output devices, such as a monitor, communications connection, etc, are shown as 216. The output device 216 communicate with computer 200 through an output interface 218.

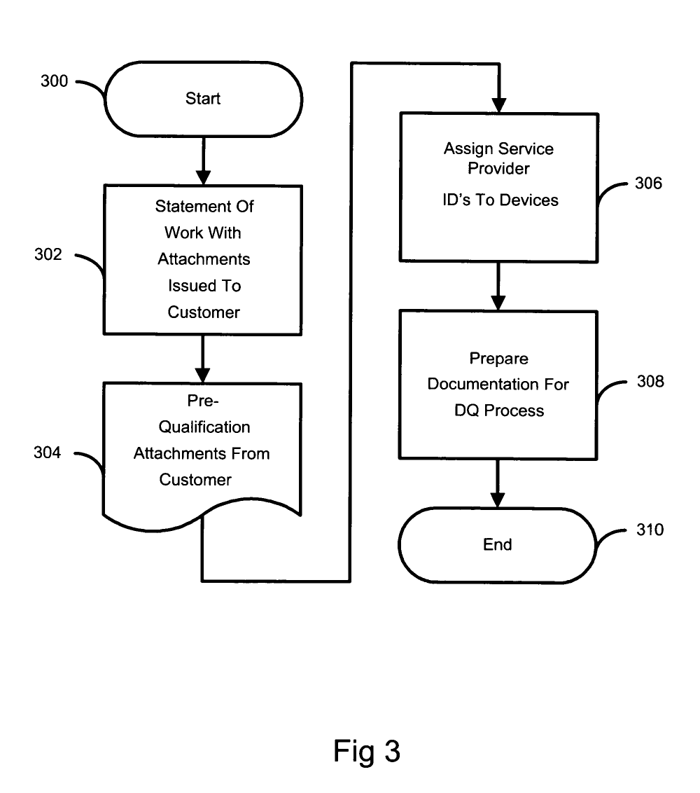

FIG. 3 displays an embodiment of a preliminary workflow implemented in accordance with the teachings of the present invention. At step 300 the preliminary workflow begins. At step 302 the service provider provides a statement of work to the customer outlining the work to be performed. Included with the statement of work are the pre-qualification documents that should be returned to the service provider to prepare the DQ.

The pre-qualification documents detail an inventory of the network. In one embodiment, the pre-qualification documents enable the service provider to (1) verify the application inventory consisting of all computers that support the application; (2) verify the infrastructure of the network; (3) identify the network monitor points in the network, and (4) verify that data can be collected from the monitor points. It should be appreciated that while specific pre-qualification documents may be described and discussed, any documents and/or methods that enable the foregoing functions may be considered pre-qualification documents and/or methods.

At step 304 the pre-qualification documents completed by the customer are returned to the service provider. In one embodiment of the present invention, the pre-qualification documents include: 1) a customer network definition form; 3) an application critical dependencies list form; 3) a managed device list form; 4) a hub and switch monitoring port list form; and 5) an application instrument list form. It should be appreciated that the foregoing forms represent one embodiment of the present invention, various embodiments may be implemented and still remain within the scope of the present invention.

The customer network definition form details the name and the application associated with each server and all clients authorized to access the application. The managed device list form details the required information for all managed switches connecting to the application's servers and clients. The Hub and Switch Monitoring Port List form details the name of the hub or switch, location, and identification of the spare port that the service provider will be permitted to use for monitoring. In one embodiment, all hubs that connect to application clients and servers are monitored. In another embodiment, servers connected to managed switches are monitored via port mirroring, port spanning, etc. The application instrument list form documents all analytical instruments by name and the client associated or dedicated to that instrument.

At step 306 the service provider assigns IDs to the devices in the following pre-qualification documents: managed device list form; the hub and switch monitoring port list form; and the application instrument list form. At step 308, the pre-qualification documents are compiled. At step 310, the process ends.

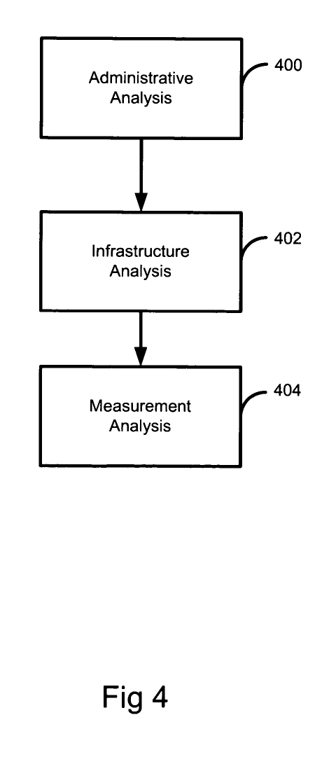

FIG. 4 displays a flow chart detailing an embodiment of a DQ 102 detailed in FIG. 1. At step 400 in the DQ process administrative analysis is performed. The administrative analysis includes a review of the customer methods and policies for managing the network. For example, a network policy assessment would be part of the administrative analysis. In one embodiment, the administrative analysis such as the network policy assessment would be analyzed in view of industry best practices. At step 402 an infrastructure analysis is performed. During the infrastructure analysis the network is defined based on identified applications. In one embodiment of the infrastructure analysis the deployment of the infrastructure and the access to the infrastructure is analyzed and documented. Lastly, measurement analysis 404 is performed. The measurement analysis 404 is performed to characterize and quantify the operation of the network.

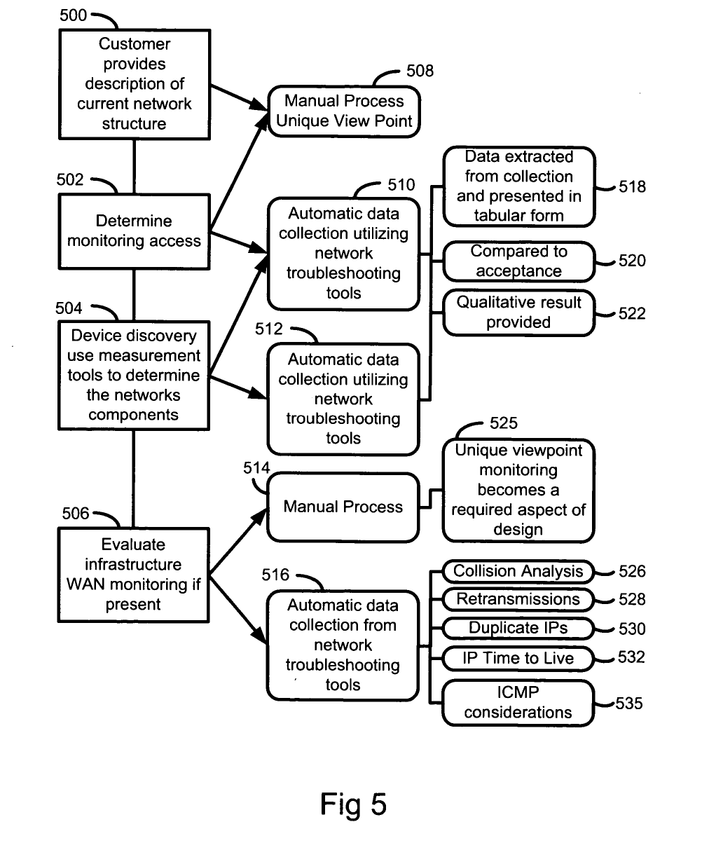

FIG. 5 displays a flow chart detailing the infrastructure analysis 402 detailed in FIG. 4. At step 500, the customer provides a description of the current network structure. The description provides a starting point in assessing network boundaries. FIG. 3 displays one methodology used to acquire a description of the network. As stated at 508, in one embodiment a manual process is used to acquire the description of the network.

At step 502, monitoring access points are determined. The monitoring access points may be acquired using a manual process 508 or an automatic data collection process, utilizing network-troubleshooting tools as stated at 510. When using the automatic data collection process 510, data is extracted, collected and presented in tabular form 518, the data is compared to acceptance criteria 520 and a qualitative result 522 is provided.

At step 504, device discovery is performed. During device discovery 504 measurement tools are implemented to determine the network components. The device discovery establishes the veracity of the network topology as provided by the customer. The device discovery may be implemented using automated data collection utilizing troubleshooting tools. When using the automatic data collection process 510, data is extracted from collection and presented in tabular form 518, the data is compared to acceptance criteria 520 and a qualitative result 522 is provided.

At step 506, the infrastructure is evaluated using monitoring techniques. In one embodiment, the network health is determined dynamically through monitoring. Both manual 514 and automatic 516 data collection techniques are used. The manual data collection 514 provides a unique viewpoint. The automatic data collection 516 is performed using troubleshooting tools. In one embodiment, the troubleshooting tools are used to monitor for collision analysis 526, retransmissions 528, duplicate IP addresses 530, IP time-to-live 532 and ICMP considerations 534.

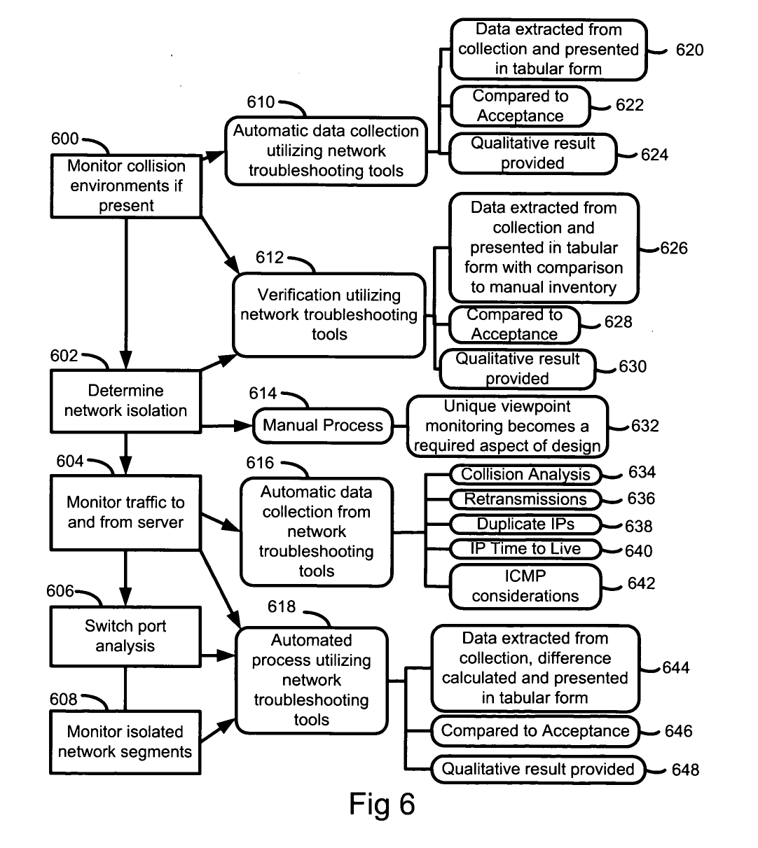

FIG. 6 displays a flow chart detailing a first stage of an embodiment of the measurement analysis 404 detailed in FIG. 4. At step 600, if a collision environment is present, the collision environment is monitored. Automatic data collection 610 and network verification 612 are implemented to monitor the collision environment. When performing the automatic data collection 610, data is extracted, collected and presented in tabular form 620, the data is compared to acceptance criteria 622 and a qualitative result 624 is provided.

At step 602 network isolation is determined. The network isolation measurements are used to determine the security of the network and the immunity of the network from unexpected loads and intrusions. Verification of the network isolation is performed using troubleshooting tools 612 and a manual process 614. When performing the verification of the network isolation using troubleshooting tools 612, data is extracted, collected and presented in tabular form with comparison to manual inventory 626, the data is compared to acceptance criteria 628 and a qualitative result 630 is provided. During the manual process 614 a unique viewpoint of the network is acquired as stated at 632 and monitoring becomes a required aspect of the design.

At step 604, traffic to and from the server is monitored. The network focus is on the requirements for the application server, as a result, traffic monitoring takes on a heightened importance. In performing the traffic monitoring 604, automatic data collection 616 is performed using network troubleshooting tools, such as collision analysis 634, retransmissions 636, duplicate IP addresses 638, IP time-to-live 640 and ICMP considerations 642.

At step 606 a switch port analysis is performed. The switch port analysis is performed since switch port error can be predictive of pending failure. In performing the switch port analysis 606 an automatic process 618 is performed using troubleshooting tools. When performing the automated process 618 for switch port analysis 606, data is extracted, collected and the difference is calculated and presented in tabular form 644, the data is compared to acceptance criteria 646 and a qualitative result 648 is provided.

At step 608 isolated network segments are monitored. Monitoring the isolated network segments verifies network isolation and provides information as to segment performance. When monitoring isolated segments an automatic process 618 is performed using troubleshooting tools. When the automated process 618 for monitoring isolated segments 608 is performed, data is extracted, collected and the difference is calculated and presented in tabular form 644, the data is compared to acceptance criteria 646 and a qualitative result 648 is provided.

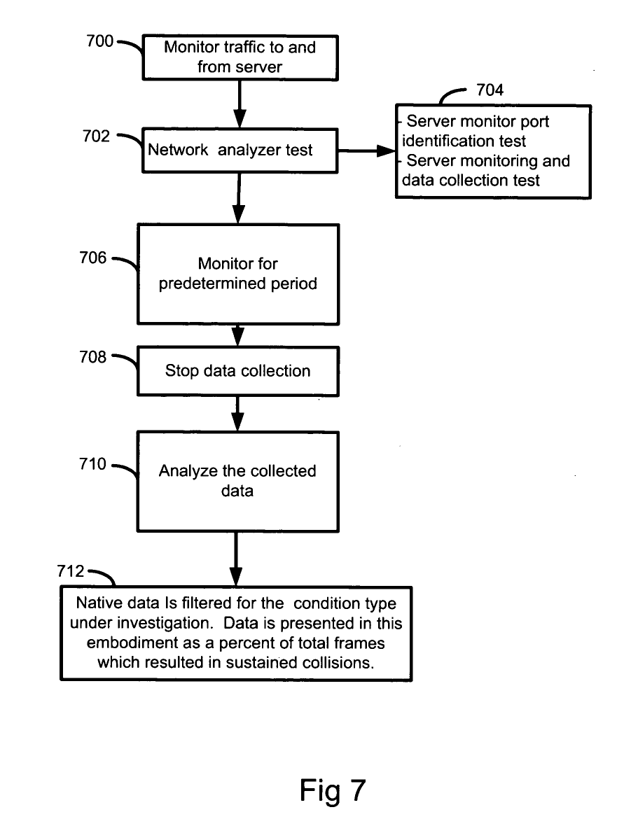

FIG. 7 displays a flow chart detailing a second stage of an embodiment of the measurement analysis 404 detailed in FIG. 4. In one embodiment, a network analyzer test 702 is used to monitor traffic to and from the server as stated in 700. The network analyzer test is used to perform a server monitor port identification test 704 and a server monitoring data collection test as stated in 704.

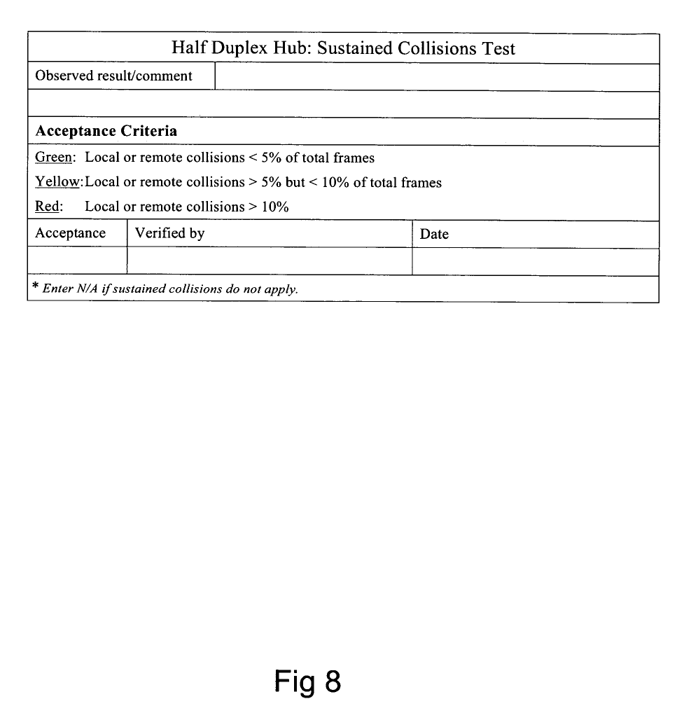

The network is monitored for a period of time as stated at 707. Once the data collection has been completed as stated at 708, the data is analyzed as stated at 710. For example, the data may be analyzed based on a Half Duplex Hub: Sustained Collisions Test. In this test, sustained high rates of collisions in a half-duplex hub environment are monitored. Such a condition can indicate that 1) the network is under-provisioned for the current use model, or 2) interface hardware of one or more devices is not following standard access conventions. The data may also be analyzed for retransmissions, duplicate IP addresses, IP time-to-Live analysis and ICMP considerations. As stated at 712, the native data is filtered for the condition type under investigation. In one embodiment the data is presented as a percent of the total frames which resulted in sustained collisions. Once the sustained collisions are tabulated, an acceptance criteria is defined. FIG. 8 displays one embodiment of a form detailing an acceptance criteria for a Half Duplex Hub: Sustained Collisions Test.

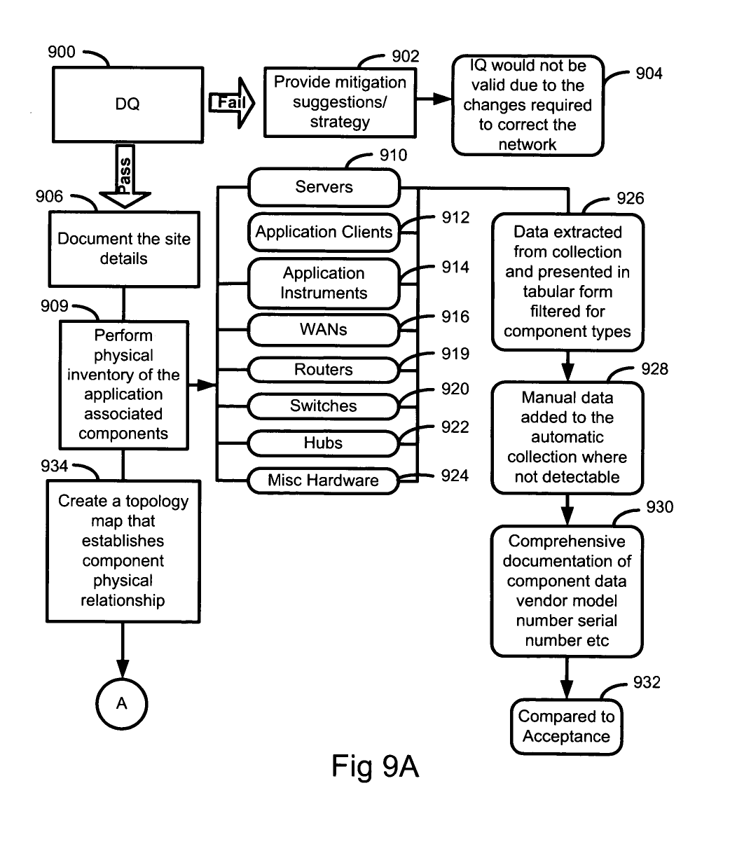

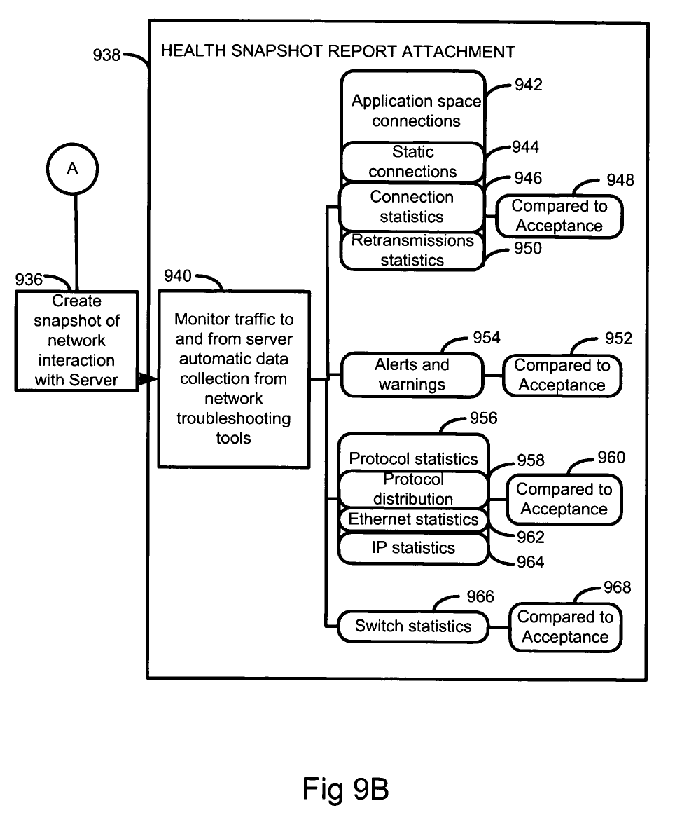

FIG. 9A displays a flow chart detailing an embodiment of an IQ 104 detailed in FIG. 1. The IQ initiates by using the output of the DQ 900. Based on the acceptance criteria defined in the DQ 900 a determination is made as to whether the DQ has passed or failed. If the DQ has failed, in one embodiment of the present invention a mitigation strategy is presented to the customer as stated at 902. The mitigation strategy is suggested since the IQ would not be valid due to the changes required to correct the network as stated at 904. If the DQ passes, the site details are documented as stated at 906. In one embodiment, the site details include the components and steps performed during the DQ. At step 909, a physical inventory of the application-associated components of the network is performed. In one embodiment, the. application-associated components include the servers 900, the application clients 912, the application instrument 914, the WANs 916, the routers 919, the switches 920, the hubs 922 and miscellaneous hardware 924. For each of the foregoing application-associated components, data is extracted, collected, presented in tabular form and filtered for component types as stated at 926. In one embodiment of the present invention, the data is automatically extracted. In addition, manual data is added to the data that is automatically collected when the data is not detectable by automatic selection as stated at 928. Comprehensive documentation of the component data such as vendor model number, serial number, etc is performed as stated at 930. The component data is then compared to an acceptance criteria as stated at 932. After performing the physical inventory of the application-associated components as stated at 909 a topology map is created to establish the component physical relationships as stated at 934.

FIG. 9B displays a flow chart detailing an embodiment of a IQ 104 detailed in FIG. 1. The topology map defined in step 934 is then used to create a snapshot of the network interaction with the identified servers as stated at 936. The result of the network interaction with the identified servers is considered a health snapshot of the network and is documented in a health snapshot report attachment 939.

In one embodiment, the health snapshot report attachment is created by monitoring traffic to and from the server using network troubleshooting tools to perform automatic data collection as stated at 940. Monitoring the traffic as stated at step 940 includes monitoring application space connections 942, alerts and warnings 952, protocol statistics 954 and switch statistics 966. Monitoring the application space connections 942 includes monitoring the static connections 944, the connection statistics 946 and the retransmission statistics 950. Each of these application space connections 942 are then compared to an acceptance criteria as stated at 949. Alerts and warnings 951 are monitored and compared to defined acceptance criteria 952. In one embodiment, monitoring the protocol statistics 954 include monitoring protocol distribution 956, monitoring Ethernet statistics 962 and monitoring IP statistics 964. The protocol statistics are then compared to the acceptance criteria 960. Lastly, switch statistics are monitored as stated at 966 and compared to acceptance criteria as stated at step 969.

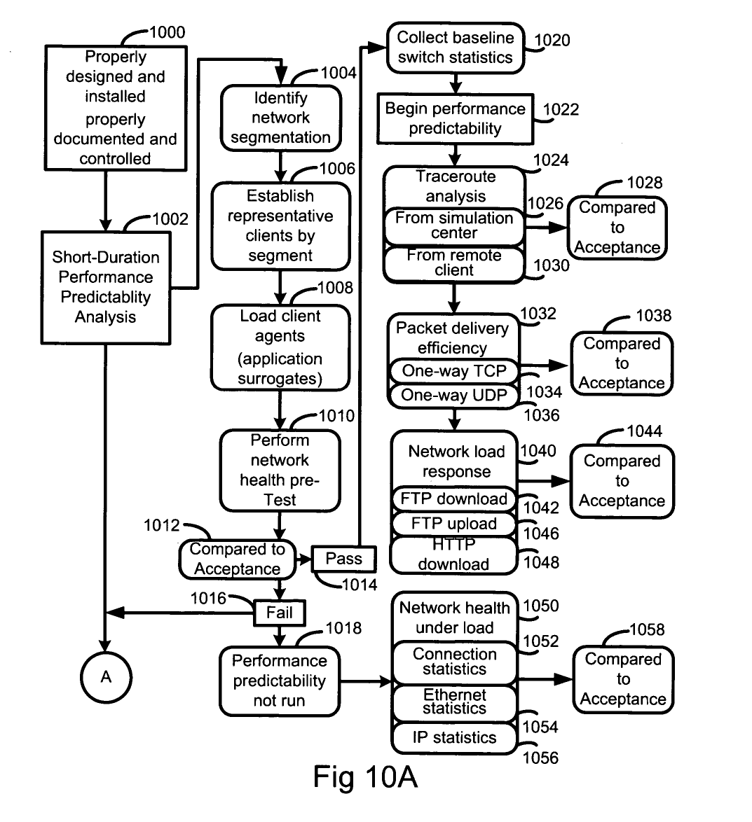

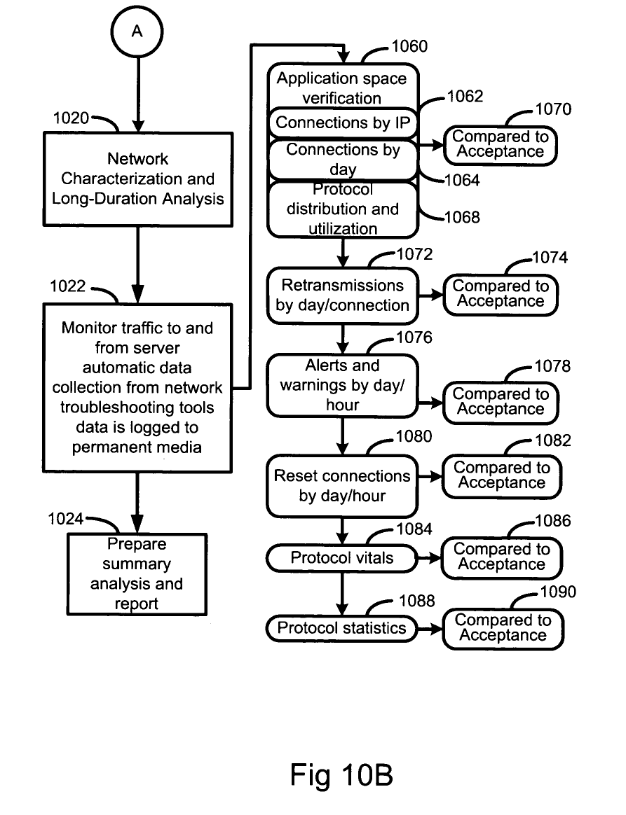

FIG. 10A displays a flow chart detailing an embodiment of a OQ 106 detailed in FIG. 1. At the conclusion of the IQ as shown in FIG. 8, the customer network has been verified to be properly designed and installed as determined by the DQ process, properly documented and controlled as determined by performing the IQ process.

In one embodiment of the OQ process both short-duration performance predictability analysis 1002 and network characterization and long-duration analysis 1020 are performed. One embodiment of the short-duration performance predictability analysis includes identifying network segments as stated at 1004, establishing representative clients by segment as stated at 1006, loading application client agents or surrogates 1008, performing network health pre-test 1010 and then comparing the network health pre-test 1010 to an acceptance criteria as stated at 1012. If the foregoing steps result in a failure, the performance predictability is not run as stated at 1018.

Should the network health pre-test 1010 pass the acceptance criteria 1012 as stated at 1014, then baseline switch statistics 1020 are collected. Once the foregoing steps have been accomplished the performance predictability analysis 1022 begins. In one embodiment of the performance predictability analysis 1022 a variety of different types of analysis is performed. For example, trace route analysis 1024 is performed, packet delivery efficiency 1032 is performed, network load response 1040 is performed and network health under load 1050 analysis is performed.

In one embodiment of the trace route analysis 1024, routes are traced from a simulation center 1026 or from a remote client as stated at 1030. The trace route is compared to an acceptance criteria 1028. In one embodiment of the packet delivery efficiency analysis 1032 a one-way TCP test 1034 is performed and a one-way UDP test 1036 is performed. The results of each test is compared to an acceptance criteria as stated at 1038. In one embodiment of the network load response 1040 an FTP download test is performed, an FTP upload test 1046 is performed and an HTTP download test 1048 is performed. Each of these test are compared to an acceptance criteria. In the network health under load response analysis 1050 connection statistics 1052 are acquired, Ethernet statistics 1054 are acquired and IP statistics 1056 are acquired. Each type of statistic is then compared to an acceptance criteria 1058.

FIG. 10B displays a flow chart detailing an embodiment of a OQ 106 detailed in FIG. 1. Network characterization and long-duration analysis 1020 is also performed. In one embodiment of the network characterization and long-duration analysis 1020, as stated at step 1022 traffic is monitored to and from previously identified servers automatically, using network-troubleshooting tools.

In one embodiment, monitoring the traffic to and from the server 1022 includes application space verification 1060, retransmission by day/connection 1072, alerts and warnings by day/hour 1076, resetting connections by day/hour 1080, protocol vitals 1084 and protocol statistics 1088. In one embodiment, application space verification 1060 includes verifying connections by IP, verifying connections by day 1064 and verifying protocol distribution and utilization 1068. Each of these verification stages is compared to an acceptance criteria as stated at step 1070. Retransmissions by day/connection 1072 is performed and the results are compared to an acceptance criteria as stated at 1074. Alert and warnings by day/hour are performed and the results are compared to an acceptance criteria. Reset connections by day/hour 1080 is performed and the results are compared to an acceptance criteria 1082. Protocol vitals 1084 are acquired and the results are compared to an acceptance criteria 1086. Protocol statistics 1088 are acquired and the results are compared to an acceptance criteria 1090. The data is logged to permanent media. At step 1024 once traffic is monitored to and from the server as stated at step 1022, in one embodiment, a summary and analysis report is prepared as stated at step 1024.

Thus, the present invention has been described herein with reference to a particular embodiment for a particular application. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

1. A method of qualifying a network comprising the steps of:
defining a network based on applications running on a network;
acquiring network test data by testing the network in response to defining the network; and
comparing the network test data to defined limits.

2. A method of qualifying a network as set forth in claim 1, wherein the step of defining the network includes the step of identifying components in the network supporting the applications.

3. A method of qualifying a network as set forth in claim 1, wherein the method of qualifying the network comprises the step of performing a design qualification.

4. A method of qualifying a network as set forth in claim 1, wherein the method of qualifying the network comprises the step of performing an installation qualification.

5. A method of qualifying a network as set forth in claim 1, wherein the method of qualifying the network comprises the step of performing an operation qualification.

6. A method of qualifying a network as set forth in claim 1, wherein the step of acquiring network test data by testing the network is performed using network troubleshooting tools.

7. A method of qualifying a network as set forth in claim 1, wherein the step of acquiring network test data by testing the network is performed automatically.

8. A method of qualifying a network as set forth in claim 1, wherein the step of acquiring network test data by testing includes applying synthetic loads to simulate short-duration stresses.

9. A method of qualifying a network as set forth in claim 1, wherein the step of acquiring network test data includes generating traffic to simulate short-duration stresses.

10. A method of performing design qualification comprising the steps of:
defining a network based on applications running on the network, the network including a network design;
testing the network in response to defining the network; and
determining suitability of the network design to run the applications in response to testing the network.

11. A method of performing design qualification as set forth in claim 10, wherein determining suitability of the network comprises determining if the network is capable of supporting the applications.

12. A method of performing design qualification as set forth in claim 10, wherein determining suitability of the network comprises determining if the network is capable of supporting critical dependencies.

13. A method of performing design qualification as set forth in claim 10, wherein determining suitability of the network comprises determining if identified components are isolated in the network.

14. A method of performing design qualification as set forth in claim 10, wherein determining suitability of the network comprises determining if identified components have the appropriate security.

15. A method of performing installation qualification comprising the steps of:
defining a network based on applications running on the network, the network including components organized in a topology;
performing measurement of the components; and
verifying the topology in response to performing the measurement.

16. A method of performing installation qualification as set forth in claim 15, wherein the step of performing measurement of the components include measuring characteristics of the components that define performance of the components.

17. A method of performing installation qualification as set forth in claim 15, wherein the measurement of the components is performed using troubleshooting tools.

18. A method of performing operation qualification comprising the steps of:
defining a network based on applications running on the network;
generating traffic on the network; and
differentiating between operation of the application and operation of the network in response to generating the traffic on the network.

19. A method of performing operation qualification as set forth in claim 18, wherein the step of generating the traffic includes generating synthetic stress loads that exercise at least one of the applications.

20. A method of performing operation qualification as set forth in claim 18, wherein the step of generating the traffic includes generating synthetic stress loads that exercise a component on the network.

21. A computer product, comprising:
computer readable instructions causing a computer to define a network based on applications running on a network;
computer readable instructions causing a computer to acquire network test data by testing the network in response to defining the network; and
computer readable instructions causing a computer to compare the network test data to defined limits.

22. A computer program embodied on a carrier wave, the computer program comprising:
instructions causing a computer to define a network based on applications running on the network;
instructions causing a computer to acquire network test data by testing the network in response to defining the network; and
instructions causing a computer to compare the network test data to defined limits.
